(19) United States
(12) Patent Application Publication
(10) Pub. No.: US 2022/0245150 A1
(43) Pub. Date: Aug. 4, 2022

(54) SEMANTIC CACHING OF SEMI-JOIN OPERATORS IN SHARED-NOTHING AND LOG-STRUCTURED DATABASES

(71) Applicant: SINDICE LIMITED T/A SIREN, Galway (IE)

(72) Inventors: Renaud DELBRU, Gradignan (FR); Stephane CAMPINAS, Talence (FR)

(21) Appl. No.: 17/597,923

(22) PCT Filed: Jul. 31, 2020
(86) PCT No.: PCT/EP2020/071709

§ 371 Date: Jan. 28, 2022

(30) Foreign Application Priority Data
Jul. 31, 2019 (IE) S2019/0126

(51) Int. Cl. G06F 16/2453; G06F 16/2455; G06F 16/27; G06F 16/23

(52) U.S. Cl. CPC G06F 16/24544; G06F 16/24552; G06F 16/2343; G06F 16/278; G06F 16/2456

(57) ABSTRACT

A method for accelerating the computation of a query execution plan involving semi-join query operators in a shared-nothing and log-structured database. In one example, the method includes the operations of: receiving a query; generating a query execution plan; using the query operator to generate a signature; and executing a query operator to generate an output. Finally, the method may include using the signature to store the output of the query operator.

### FIELD OF THE INVENTION

The present disclosure relates to processing database queries and, in particular, to caching results of a semi-join operator in distributed, shared-nothing and log-structured databases.

### BACKGROUND OF THE DISCLOSURE

A distributed database system can be based on a shared-nothing and log-structured (append-only) architecture [ONE96], which can be key-value stores, document stores, graph stores or columnar data stores. Many modern databases such as Apache Cassandra® [LAK10], Bigtable™ [FAY08], Apache HBase™, and Elasticsearch™ are based on this type of architecture.

In a shared-nothing distributed database architecture, the database system runs on a cluster of computing nodes in which each computing node is independent from the other. The data collection is partitioned and distributed across the nodes. A data table is logically divided into one or more non-overlapping data table partitions, also called data table shards. Each node can have one or more data table shards that are themselves independent from each other. A data table shard can be replicated over one or more nodes to handle failover scenarios.

In a log-structured database, a data partition is organised as a series of one or more data segments of increasing sizes. A data segment is self-contained and may include its own index, cache, and other data structures. Updates are appended to a new data segment instead of overwriting records in an existing data segment. Stale data is marked as deleted in a segment. A process called compaction or merge is performed by the system and consists of rewriting one or more segments into a new larger segment, in order to optimize I/O and remove stale data.

Each data record is associated with an internal record identifier. This identifier is local to a data segment and is usually an integer that is incremented for each new record. Such internal record identifiers are keys to high performance due to their incremental nature, because:
they enable efficient sequential scan (access to data in its physical order);
They allow fast record lookup, usually without the need of an index since the identifier can be easily mapped to its physical address; and
they can be compressed efficiently, so that they can be used in bitmap structures.

### Semantic Caching

In database systems, an advanced caching mechanism facilitates efficient query processing and reduces the query response time. Caching frequently accessed data not only improves the user's experience of the database system, but also reduces the server's workload and increases its scalability. Page caching is a model where disk pages or tuples are cached and can be retrieved by their identifiers. Compared to page caching, query caching exploits the idea of reusing cached query results to answer new queries. The earliest work on query caching is the semantic caching model [DAR96].

In the semantic caching model, a semantic definition of the query and its associated results are stored in the cache. When a new query is received by the system, it can be compared with the existing semantic definition of the cached queries present in the cache. The new query can then be totally or partially answered by the cached queries. If the query is only being partially answered, the query is trimmed from the cached ones and a remainder query is sent to the server. The semantic caching model is widely used in different systems such as search engines and database systems.

Although several important principles of semantic query caching have been proposed, conventional semantic query caching techniques do not provide efficient methods for evaluating or comparing join operations against cached entries.

Existing methods are limited to capturing the semantics of the query. This strategy is not robust against data changes and may lead to incorrect results being returned unless a complex maintenance operation is performed. In addition, this may lead to many cache entries being evicted unnecessarily, reducing the cache efficiency.

Moreover, storing the results of a join operation is equivalent to storing potentially large data tables. This is costly in terms of memory and therefore limits the number of cached entries in the system. A small number of cached entries reduces the chance of a cache hit and limits the efficiency of the cache. In addition, the size of the results has an impact on the network communication, because the results must be transferred to the cache storage area.

In view of the above-described technologies, there is a need for a method that addresses at least the problems that are outlined above.

### REFERENCES

US20050240570A1—Partial query caching, April 2004.
U.S. Pat. No. 6,347,314B1—Answering queries using query signatures and signatures of cached semantic regions, May 1999.
U.S. Pat. No. 8,965,879B2—Unique join data caching method. June 2011.
US20070208690A1—Detecting and processing cache hits for queries with aggregates. June 2002.
U.S. Pat. No. 7,395,258B2—System and method for adaptive database caching. April 2004.
U.S. Pat. No. 5,822,749A—Database system with methods for improving query performance with cache optimization strategies. July 1994.
[ONE96] O'Neil, Patrick, et al. “The log-structured merge-tree (LSM-tree).” Acta Informatica 33.4 (1996): 351-385.
[FAY08] Chang, Fay, et al. “Bigtable: A distributed storage system for structured data.” ACM Transactions on Computer Systems (TOCS) 26.2 (2008): 4.
[LAK10] Lakshman, Avinash, and Prashant Malik. “Cassandra: a decentralized structured storage system.” ACM SIGOPS Operating Systems Review 44.2 (2010): 35-40.
[DAR96] Dar, Shaul, et al. “Semantic data caching and replacement.” VLDB. Vol. 96. 1996.

### SUMMARY OF THE INVENTION

A first aspect of the present disclosure provides a method for accelerating the computation of a query execution plan involving semi-join query operators in a shared-nothing and log-structured database; the method comprising:
receiving a query;
generating a query execution plan, wherein the query execution plan comprises a plurality of query operators;
using the query operator to generate a signature;
executing a query operator to generate an output; and
using the signature to store the output of the query operator.

Preferably, wherein executing a query operator to generate the output further comprises:
using the signature to retrieve a stored output of the query operator.

Ideally, wherein generating the query execution plan further comprises:
rewriting a semi-join query operator to output record identifiers instead of the record itself.

Preferably, wherein generating a query execution plan further comprises:
rewriting a semi-join query operator into a query operator that reuses stored output to generate its output.

Ideally, wherein the output of the query operator is stored in a cache storage area.

Preferably, the method further comprising:
dividing the cache storage area into one or more data table storage areas, data partition storage areas and data segment storage areas to preserve consistency of the record identifiers.

Ideally, the method further comprising:
distributing the cache storage area across one or more of the data table storage areas, data partition storage areas and data segment storage areas.

Preferably, wherein the data table storage areas are identified by a data table identifier, the data partition storage areas by a data table partition identifier and the data segment storage areas by a data table segment identifier, further comprising deriving a global record identifier from the data table identifier, data table partition identifier and the data table segment identifier.

Ideally, wherein using the query operator to generate the signature further comprises:
capturing the semantics of the query operator using its type, definition and lineage; and/or
capturing the semantics of a data table using its state.

Preferably, wherein the state of the data table includes a set of records filtered by a plurality of filter operators.

Ideally, wherein using the query operator to generate the signature further comprises:
generating a signature for a data table segment using a list of record identifiers;
generating a signature for a data table partition combining one or more signatures of data table segments;
generating a signature for a data table combining one or more signatures of data table partitions.

Preferably, wherein executing the query operator to generate the output further comprises:
acquiring a table read lock before generating the signatures of the query operators;
acquiring a cache read lock when searching the signature in the cache storage area.

Ideally, wherein the acquisition of the table read lock further comprises:
storing a reference of a data table segment at a time t;
using a reference of a data table segment in the query plan execution.

Preferably, wherein the acquisition of a cache read lock in a distributed shared-nothing and log-structured storage system may further comprise:
storing a reference of a cache entry at a time t;
using a reference of a cache entry in the query plan execution.

A second aspect of the present invention provides a non-transitory computer readable medium storing a program configured to instruct a processor to:
receive a query;
generate a query execution plan, wherein the query execution plan comprises a plurality of query operators;
use the query operator to generate a signature;
execute a query operator to generate an output; and
use the signature to store the output of the query operator.

A third aspect of the present invention provides an apparatus for accelerating the computation of a query execution plan involving semi-join query operators in a shared-nothing and log-structured database, the apparatus comprising:
Means for receiving a query;
Means for generating a query execution plan, wherein the query execution plan comprises a plurality of query operators;
Means for using the query operator to generate a signature;
Means for executing a query operator to generate an output; and
Means for using the signature to store the output of the query operator.

The present invention provides a method to alleviate the limitations that are described above. The method captures not only the semantics of the query but also the semantics of the data tables that are referenced in the query. This increases the efficiency of the cache by making cached entries more robust against data changes while avoiding returning incorrect or stale results. We further enhance the method by pushing parts of the semantic query model down to the semantic data model. This enables us to find equivalence between semantically different queries and to map them into one single cached entry, increasing further the efficiency of the cache.

The method further proposes a caching mechanism that is distributed across multiple computing nodes and scales horizontally with the number of computing nodes. The caching mechanism leverages data locality and reduces network communication between computing nodes.

The method proposes a strategy to encode efficiently in a compact format the results of semi-join operations. Such a strategy reduces significantly the cost of storing the results of semi-join operations and increases the efficiency of the cache. Further optimizations are proposed for encoding the results of semi-join operations by taking advantages of the properties of log-structured databases.

These and other features will be better understood with reference to the following figures which are provided to assist in an understanding of the present teaching, by way of example only.

### BRIEF DESCRIPTION OF THE DRAWINGS

FIG. 1 illustrates an exemplary computer system, according to an embodiment of the present disclosure.

FIG. 2 is a query example that retrieves the names of all customers who have performed an order with a total price that is over 500;

FIG. 3 is a query execution plan that has been generated from the query example of FIG. 2;

FIG. 4 is a query execution plan that has been optimized by the coordinator from the query example of FIG. 2;

FIG. 5 is a diagram of the query execution plan from FIG. 2 that specifies the schema of the intermediate table outputs;

FIG. 6 is a diagram showing the previously described method of generating the table output of a semi-join query operator by using a scan operator;

FIG. 7 is a diagram illustrating the structure of the cache storage area;

FIG. 8 is a diagram illustrating a method in which a data table partition will store locally its corresponding data table partition storage area;

FIG. 9 is a diagram illustrating a method of generating a signature in a distributed log structured database, according to an embodiment of the present disclosure;

FIG. 10 is a flowchart illustrating a method of executing a query according to an embodiment of the present disclosure;

FIG. 11 is a flowchart illustrating a method using table and cache read locks;

FIG. 12 is a flowchart illustrating a method of obtaining a table read lock in a distributed log structured database, according to an embodiment of the present disclosure;

FIG. 13 is a flowchart illustrating a method of obtaining a cache read lock in a distributed log-structured database, according to an embodiment of the present disclosure;

FIG. 14 illustrates a Query Execution Plan; and

FIG. 15 illustrates a Query Example.

### DETAILED DESCRIPTION

Embodiments of the present disclosure will now be described with reference to some exemplary apparatus and systems described herein. It will be understood that the embodiments that are described are provided to assist in an understanding of the present disclosure and are not to be construed as limiting in any fashion. Furthermore, modules or elements that are described with reference to any one figure may be interchanged with those of other figures or other equivalent elements.

The present disclosure may be implemented as a system, a method, and/or a computer program product. FIG. 1 illustrates an exemplary computer system, according to an embodiment of the present disclosure. The computer system comprises one or more nodes 103. A node is a database system process that includes computer-readable program instructions to carry out aspects of the present disclosure. For example, a node may include instructions to carry out the necessary functions of a coordinator 104 or of a computing unit 106. Nodes may be interconnected by a network 105. One or more computer-readable storage medium 107 may be attached to a computing unit node. One or more data table partitions 108 and one or more cache storage areas 109 may be stored on a computer-readable storage medium. A computing unit node may carry out various functions, such as (but not limited to) maintenance operations on the table partitions, scanning table partitions, transferring data to other computing unit nodes, executing join operations. A client 101 may interact with the computer system through the coordinator node by sending a query 102.

The computer program product may include a computer-readable storage medium (or media) having computer-readable program instructions thereon for causing a processor to carry out aspects of the present disclosure. Examples of computer-readable storage medium include, but are not limited to: magnetic media such as hard disks, floppy disks and magnetic tape; optical media such as CD-ROMs and DVDs; and hardware devices such as ROM or RAM. Examples of computer-readable program instructions include machine instructions such as those that are produced by a compiler and higher-level instructions that are interpreted by another computer program.

Any distributed database system that is based on shared-nothing and log-structured (append-only) architecture, which can be for example key-value stores, document stores, graph stores or columnar data stores that perform join operations, may benefit from the present disclosure. In particular, the present disclosure can be beneficial for data analytics platforms that are based on such distributed database systems in domains including (but not limited to) business intelligence, operational intelligence, data investigation, security information and event management, log analysis, and so on. The join operations may be used, for example, to correlate records from different tables and different data sources, create views by joining multiple tables into a single table, and support relational navigation techniques such as “relational drill down” and data exploration in relational faceted systems. For example, the present disclosure may be leveraged in data investigation platforms to reduce latency and cluster load in operations such as relational navigation between dashboards, computing views by joining multiple tables, alerting on complex relational queries, correlating a large number of records into a graph representation, and so on.

### The Semi-Join Operator

A semi-join is a binary operator that takes two data tables as inputs—the left and the right input tables—and produces one data table as output. The input data table may be a physical table that is stored on disk or in memory, or an intermediate table that is created by the database. An intermediate table stores temporary data that is used to calculate the final result set, for example, the table output of another query operator.

A semi-join is similar to a regular join, except that only records from the left data table are kept, based on a match condition with the right data table. The output of a semi-join is a data table that is composed of one or more records and one or more columns from the left data table.

In a distributed, shared-nothing environment, records from the left and right data tables are scanned and shuffled across the network, before being joined. The cost depends on the implementation of the semi-join. For example, if a broadcast join implementation is used, the smallest table is replicated to all of the partitions of the largest relation. If a Hash Join or a Sort-Merge Join is used, the two relations are shuffled across the nodes. In any case, the cost is significant, and caching a semi-join operator is needed to reduce the overall costs of the query execution plan.

### The Query Execution Plan

The database coordinator is a database process that coordinates the execution of a query within the database system. When a query is sent to the coordinator, the coordinator generates a query execution plan. A query execution plan is a higher-level representation of the query which may comprise a plurality of query operators, including but not limited to join, semi-join, filter, scan, etc. In an embodiment, the query execution plan may be represented as a directed acyclic graph of query operators. A query operator may have one or more child query operators, indicating a direct dependency between the parent operator and its children. The output table of a child operator will act as one of the inputs of the parent operator. The coordinator may apply rules and other strategies to rewrite and optimize the query execution plan into its most simple canonical form.

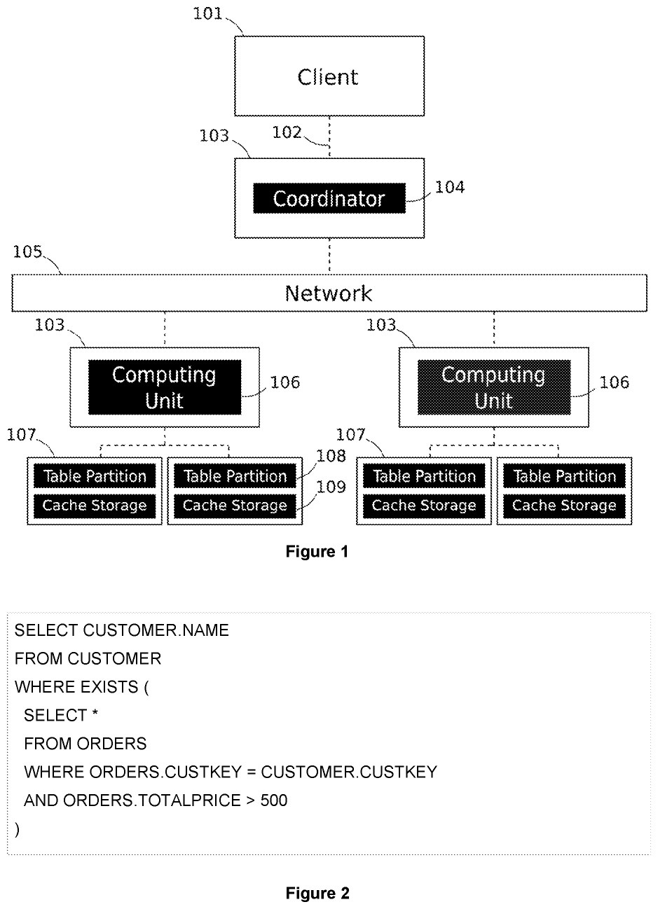

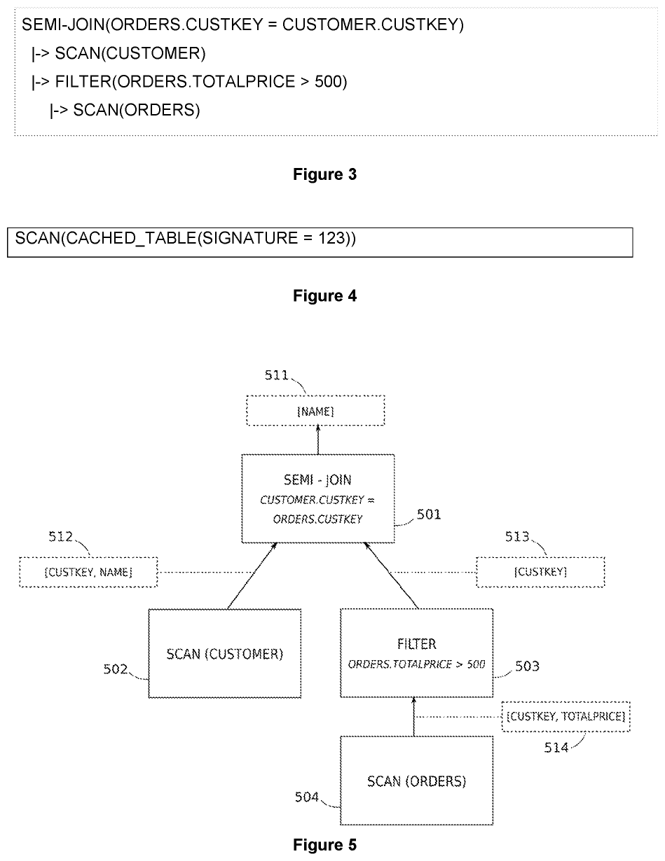

FIG. 2 is a query example that retrieves the names of all customers who have made an order with a total price over 500. Records from the CUSTOMER table are filtered based on the records from the ORDERS table. FIG. 3 is a query execution plan that has been generated from the query example of FIG. 2. The query execution plan includes a semi-join query operator with a condition on the CUSTKEY attribute. The semi-join operator has two child operators, a scan operator of the CUSTOMER table and a filter operator with a condition on the TOTALPRICE attribute. The filter operator has a single child operator; a scan operator of the ORDERS table.

After the query execution plan is generated, the coordinator will traverse the query execution plan from top to bottom in order to search for query operators with an associated cached table output. In an embodiment, the coordinator may use a depth-first search strategy for the traversal. The objective is to first find the query operators that subsume the largest part of the graph in order to prune the query execution plan and avoid executing the query execution plan completely. If a query operator with a cached table output is found in the cache storage area, the coordinator may skip the traversal of its children and may optimize the query execution plan by replacing the query operator and all its children with a new query operator indicating that the table output may be fetched from the cache storage area. FIG. 4 is the query execution plan from FIG. 3 that has been optimized by the coordinator after finding a cached table output for the semi-join operator. The semi-join operator and its descendant operators are replaced by a scan operator over a cached table output, which is associated with a signature of 123.

To search for a cached table output of a query operator, the coordinator generates a signature from the query operator. The signature is used to search the cache storage area and to find an associated cached table output. A signature is a canonical representation of the query operator that tries to capture its semantics. A signature is used to compare query operators across multiple query execution plans. Two query operators with an identical or a similar definition and producing the same table output may have the same signature. A signature may capture semantics with different granularity levels, i.e., it may summarize different degrees of information provided by a query operator. The semantic granularity of a signature impacts the efficiency of the caching. This will be discussed later.

### Caching of a Semi-Join Operator

Storing the output table of a semi-join operator, i.e., a collection of records, is costly in terms of memory. Each record may be composed of one or more columns, each one with a different data type. For example, a data type can be, but is not limited to, a numerical value such as long or integer, a binary value such as text, or more complex data types such as arrays or objects. The size of a record depends on the number of columns and the column data type. In a worst-case scenario, when all the records and all the columns are projected, it is equivalent to replicating and storing the original left input table in the cache storage area.

Given that the size of the cache storage area is limited, the size of a record determines the number of records that can be stored in the cache storage area, which itself determines the number of data tables that can be stored in the cache storage area. A small number of data tables stored in the cache storage area reduces the chance of a cache hit and limits the efficiency of the cache. In addition, this has also an impact on the network communication, as the output table must be transferred to the cache storage area.

With respect to the semi-join operator, an alternative method is possible given that the output table is a subset of the left input table. Instead of storing the record itself, a record identifier is stored. Given a list of record identifiers and a list of columns to project, the output table can be generated by scanning the left input table and by filtering out records that are not present in the list. Such a strategy may reduce significantly the cost of storing a table output and increases the efficiency of the cache. The size of a cached record is now the size of the record identifier. Further optimizations related to the encoding of the record identifiers are described later.

FIG. 5 is a diagram of the query execution plan from FIG. 3 that specifies the schema of the intermediate table outputs. The query execution plan includes a semi-join query operator 501 with an equality condition between the CUSTOMER.CUSTKEY and ORDER.CUSTKEY attributes. The table output 511 of the semi-join operator is composed of one column; CUSTOMER.NAME. The semi-join operator has two child operators, a scan operator 502 of the CUSTOMER table and a filter operator 503 with a condition on the ORDER.TOTALPRICE attribute. The filter operator has a single child operator, a scan operator 504 of the ORDERS table. The table output 512 of the scan operator 502 is composed of two columns; CUSTOMER.CUSTKEY and CUSTOMER.NAME. The table output 514 of the scan operator 504 is composed of two columns; ORDER.CUSTKEY and ORDER.TOTALPRICE. The table output 513 of the filter operator 503 is composed of one column; ORDER.CUSTKEY.

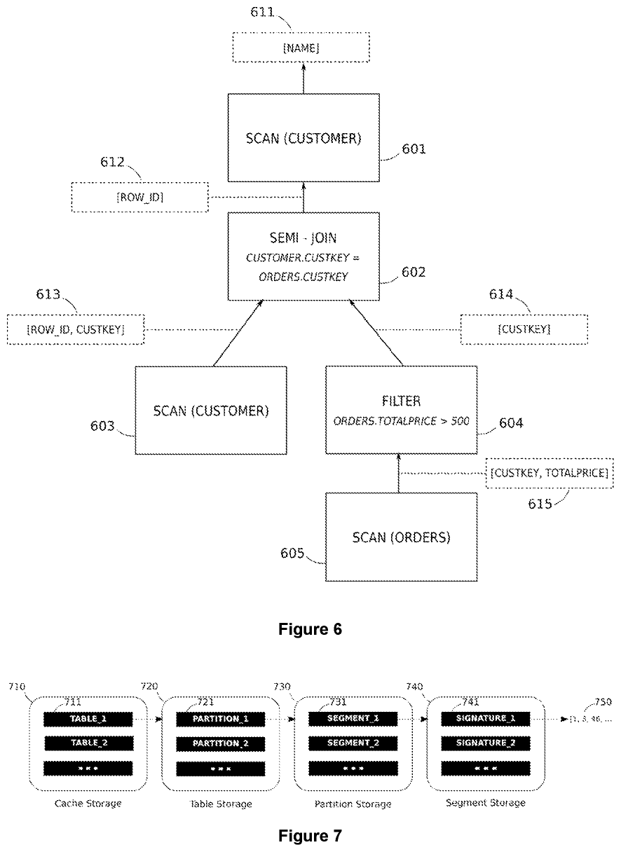

FIG. 6 is a diagram showing the previously described method of generating the table output of a semi-join query operator by using a scan operator. Compared to the scan operator 502, the scan operator 603 of the CUSTOMER table projects the record identifier CUSTOMER.ROW_ID instead of the column CUSTOMER.NAME. The table output 613 of the scan operator 603 is composed of two columns; CUSTOMER.ROW_ID and CUSTOMER.CUSTKEY. Compared to the semi-join operator 501, the semi-join operator 602 applies the equality condition on the CUSTOMER.CUSTKEY and ORDER.CUSTKEY attributes and projects the record identifiers CUSTOMER.ROW_ID, satisfying the equality condition. The table output 612 of the semi-join operator 602 is composed of one column; CUSTOMER.ROW_ID. The final table output 611, i.e., the list of customer's names, is generated by performing a scan operator 601 on the CUSTOMER table and by filtering out records for which an identifier is not present in the table output 612, which is generated by the semi-join operator. Once a table output such as 612 comprising record identifiers is cached, the coordinator may retrieve the cached table and may rewrite the query execution plan as a single scan operator 601 on the CUSTOMER table and by filtering out records for which an identifier is not present in the cached table output 612.

### Global Record Identifiers

In the method described previously, a record identifier is a core unit of information stored in a cached data table. The record identifier is used to find and retrieve a record from the original data table. In a distributed shared-nothing database architecture, a record identifier must be able to globally identify a record, i.e., across all the data table partitions. A global record identifier is required for the interoperability between the cached data table and the original data table.

One problem with respect to the shared-nothing architecture is that assigning and maintaining a global record identifier across the cluster is costly and in fact goes against the shared-nothing architecture. It would require a global coordination across the cluster to identify each single record. One may use a hash (based on the record) or a UUID as a global record identifier, but this means that we are losing all of the benefits mentioned earlier of using an internal, incremental-based identifier, which would lead to an increase in I/O, memory and network costs.

Instead, one may use the properties of the log-structured data model. In a log-structured database each data segment identifies a record with an incremental identifier, which is relative to the data segment. A global record identifier may be derived by combining the data partition identifier, the data segment identifier and the relative record identifier. However, there is no constraint on the consistency of such a record identifier given that a compaction will rewrite modified records in a new data segment and at a new position. Without such a consistency, the interoperability between the cached table and the original data table is not maintained.

In order to keep the consistency of record identifiers between the original data table and the cached table, the cache storage area must follow the log-structured model and replicate the segment-level data structure of the original data table. With this design, which is presented next, the data partition identifier, the data segment identifier and the relative record identifier can be compared between the original data table and the cached data table and consistency is preserved.

### Cache Storage Area

FIG. 7 is a diagram illustrating the structure of a cache storage area. The cache storage area 710 is divided into one or more data table storage areas. A data table storage area 720 is identified by a data table identifier 711 and is divided into one or more data table partition storage areas. A data table partition storage area 730 is identified by a data table partition identifier 721 and is divided into one or more data table segment storage areas. A data table segment storage area 740 is identified by a data table segment identifier 731 and is divided into one or more cache entry. A cache entry 750 is identified by a query operator signature 741 and is associated to a list of record identifiers that are relative to the data table segment. A global record identifier may be derived from the data table identifier, data table partition identifier, data table segment identifier and the relative record identifiers.

In an embodiment, the record identifiers in a segment may be incremental and may be encoded in a bit array structure. The size of the bit array structure is bounded by the number of records in the data table segment. This encoding provides a significant reduction in the storage and is suitable for caching large data tables.

In an embodiment, the cache storage area may be located on the client or the coordinator side. However, this is far from optimal as the data table partitions of the cached data table must be first transferred across the network to their corresponding data table partition prior to scanning and filtering the latter.

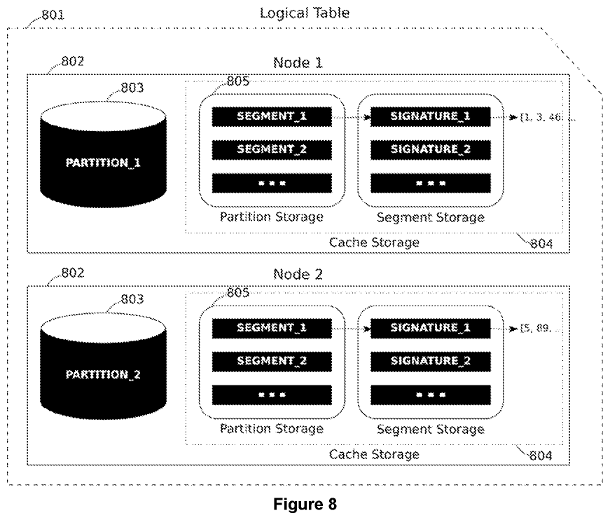

Another method is to distribute and store the cache storage area across the data table partitions. FIG. 8 is a diagram of a method 800 in which a data table partition stores locally its corresponding data table partition of the cache storage area. A logical table 801 is distributed across one or more computing nodes 802. A computing node may store one or more data table partition 803 and one or more cache storage area 804. A cache storage area 804 is associated to one data table partition 803. A cache storage area includes a data table partition storage area 805, similar to 730, and is divided into one or more data table segment storage areas, similar to 740. The exemplary computer system depicted in FIG. 1 uses this method. This enables horizontal scaling of the cache storage area with the number of available computing nodes in the cluster. Filtering of the data table partition based on a cached entry is done locally while scanning, eliminating the need for data transfer and avoiding unnecessary data serialization.

The coordinator may decide based on the cost to use different strategies for scanning and filtering the data table partition. In an embodiment, the coordinator may use a sequential scan or an index scan if an index is available. In an embodiment, the coordinator may leverage the internal record identifiers and use an efficient bitmap scan strategy using fast record lookup by mapping the internal record identifier to its physical address, which eliminates reading and decoding of unnecessary records. In an embodiment, the bitmap scan strategy may scan internal record identifiers sequentially to optimize the reading of disk pages.

We have shown that by using bit arrays for encoding record identifiers and by distributing the cache storage area horizontally, we can increase significantly the number of data tables that we can store in the cache storage area, thus improving the efficiency of the caching.

### Semantic Signature of the Semi-Join Operator

A signature is derived from a query operator. The signature is used to capture the semantics of a query operator and to identify the table output of a query operator in the cache storage area. When a query operator produces a signature that is stored in the cache storage area, the associated cached table output may be retrieved from the cache storage area and may be used to produce the table output of such a query operator. When a query operator that is producing the same signature is found across multiple queries, the method enables the coordinator to reuse a previously computed and cached version of the table output for such a query operator.

The computation of a signature may vary based on the type and definition of the query operator. In order to fully capture the semantics of the query, the definition of a query operator must encode its lineage, i.e., the definition of its child operators. In an embodiment, the signature of a scan operator may encode the identifier of the data table being scanned and the set of table columns being projected. The signature of a filter operator may encode its filter condition and a reference to its child operator. The signature of a join operator may encode its join condition and a reference to both its left and right child operators.

A signature that captures only the semantics of the query is not robust against data changes. For example, if one of the data tables that is referenced by a scan operator is modified, a method that is based solely on the semantics of the query will not be able to capture such a change, and the scan operator will produce the same signature. This may lead to incorrect results being returned unless a complex maintenance operation is performed. A maintenance process may have to search and delete all cache entries related to the modified data table. In an embodiment, this may require a full scan of the cache storage area and a decoding of every signature in order to find if a signature references the modified data table. In addition, this may lead to many cache entries being evicted unnecessarily reducing the cache efficiency.

Instead a signature must capture not only the semantics of the query but also the semantics of the data tables that are referenced in the query. The semantics of a data table may be derived from its state or in other words its set of records. If the state of the data table changes, the signature of the data table may be different. A cache entry that is associated with the data table may become stale, because its signature may refer to an old version of the data table. This prevents incorrect results from being returned and may simplify the maintenance process. In an embodiment, the cache storage area may use a Least Recently Used (LRU) eviction strategy to automatically discard stale cache entries.

The semantics of a data table may have different levels of granularity, which may impact the efficiency and the performance of the cache. A low granularity level provides the most precise representation of the data table state, but it is expensive to compute. A high granularity level may be efficient to compute, but it may lead to unnecessary evictions. The challenge is to find methods that offer the best compromises.

In an embodiment, the state of the data table may be captured using the version of the data table. A version of a data table may be a numerical value that is incremented for every individual modification of the data table. A signature that is based on a data table version is cheap to compute but it is not very effective. A signature that is based on a data table version is not granular enough to detect that a change does not impact the result set of a query. For example, in the query from FIG. 2, if the ORDERS data table is modified by adding or removing a record with a total price that is less than 500, the signature of the data table will be different, which will impact the signature of the FILTER, SCAN and SEMI-JOIN operators. However, we can observe that such a data table modification does not impact the table output of the FILTER query operator and consequently does not impact the result sets of the query.

In an embodiment, the state of the data table may be captured based on its set of records. A signature may be generated by scanning all the records, computing a hash value for each record, and combining them into a sequence. This method has the same limitation as the previous one, because the signature of the data table captures the state of the data table before the FILTER operator and it is unaware of the filtered records.

In an embodiment, the signature of the data table may be recorded after the FILTER operator, on the filtered set of records. It is therefore important during the query execution plan generation and optimization to push as many FILTER operators as possible down to the SCAN of the data table. Using this method, if a data change does not impact the table output of the FILTER operators, the signature will be identical. In the previous example, all records from the ORDERS table with a total price that is less than 500 will be filtered out and will not be taken into consideration in the computation of the signature. The modification of one of those records will not impact the computation of the signature.

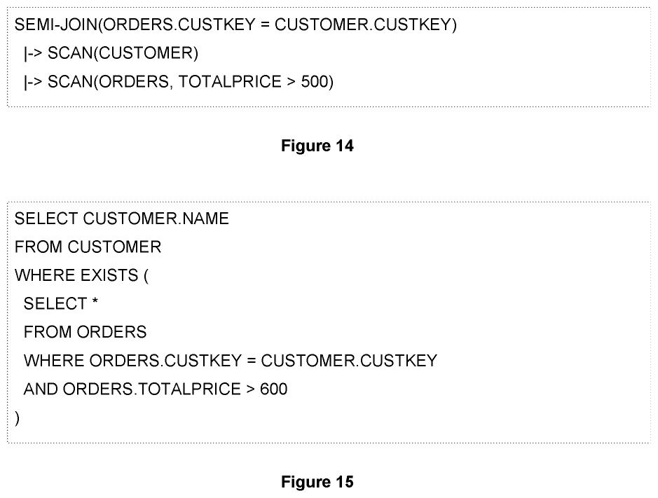

Pushing down the execution of the FILTER operators into the SCAN of the data table and computing the signature of the data table based on the filtered set of records means that we are implicitly capturing the FILTER operators in the data table signature. Therefore, we are making the FILTER operators redundant in the semantics of the query and they can be safely removed when computing the signature of a query operator. In an embodiment, this can be implemented by generating a query execution plan as shown in FIG. 14. In this figure, the FILTER operator has been pushed down inside the SCAN operator. The signature of the SCAN operator is generated based on the set of records in its table output, instead of being generated based on the query operator definition.

This method leads to an additional improvement that makes the signature more robust against changes in the query syntax itself. Given two different filter operators, if they produce the same set of records, then the signature of the data table will be identical. For example, the queries of FIGS. 2 and 15 are syntactically different given that they do not have the same filter condition. However, if the ORDERS table does not contain records with a total price between 500 and 600, then the two queries are producing the same results set. The table output of the semi-join of FIG. 2 may be reused to generate the table output of the semi-join operator of FIG. 15.

One challenge is to compute this signature as efficiently as possible in order to not increase significantly the response time of the query. Scanning the full table, applying filters and hashing individual records may be costly especially on large data tables.

In an embodiment, each individual filter may be computed efficiently with an appropriate index data structure. The filters and its associated list of matching record identifiers may be cached in the cache storage area. The list of matching record identifiers may be encoded in a bit array data structure. Individually cached filters may be reused across queries by combining them using conjunction, disjunction and negation operators.

Hashing individual records is another operation that is costly in terms of I/O and CPU: the record may be fully read from the data table and it is costly to compute a hash value from the full record. A more efficient method is presented here leveraging the log-structured storage system. As explained previously, an existing data table segment is never modified in a log-structured storage system. If a record is modified, it is marked as deleted in its original data table segment, and the new record is added to a new data segment. Instead of relying on the hash value of a record to generate the signature, we can rely on a global record identifier that is derived from the data table partition identifier, the data table segment identifier, and the local record identifier—relative to the data table segment.

In an embodiment, the strategy may be implemented efficiently by leveraging the list of record identifiers that is produced by the filter operators. A filter operator may produce a list of local record identifiers for each data table segment. Such a list may be computed based on an index structure, or may be cached and retrieved from the cache storage area. A list of local record identifiers may be combined with others to produce the final list of local record identifiers matching the entire set of filter conditions. In an embodiment, a bit array data structure may be used to encode the list of matching record identifiers in a data table segment. Similarly, in an embodiment, a hash value may be generated from the list of matching record identifiers in a data table segment. Finally, a signature may be generated by combining the list of local record identifiers for every data table segment.

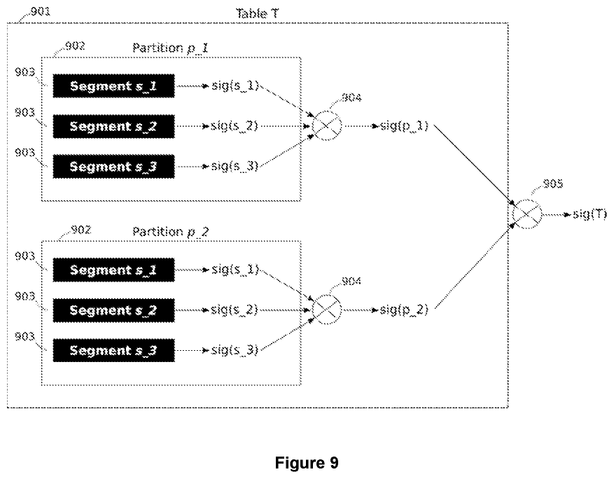

FIG. 9 is a diagram showing a method 900 of generating a signature in a distributed log-structured database, according to an embodiment of the present disclosure. A data table T 901 comprises two data table partitions 902; p_1 and p_2. Each data table partition comprises three data table segments 903; s_1, s_2 and s_3. For each segment s_i, a signature sig(s_i) is derived from a list of matching record identifiers. For each partition p_i, the segment signatures are combined into a partition signature sig(p_i), using an operator 904. The partition signatures are then combined into a data table signature sig(T), using an operator 905.

The trade-off is that the signature is not robust against merge operations of data table segments if the merged segments contain records that might impact the results set of the query. This trade-off may be acceptable in systems with low-frequency updates and where low latency response time is critical.

It is to be noted that such a signature strategy, based on the semantics of the data table, may be used for other operators than those described in the previous examples and are not limited to semi-join. For example, a cached table output from an inner join operator may be identified with such a signature to detect if its content is stale.

### Executing a Query

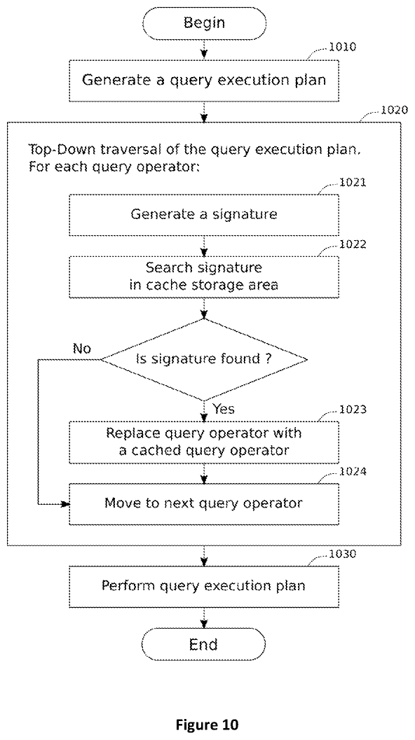

FIG. 10 is a flowchart showing a method 1000 of executing a query according to an embodiment of the present disclosure. FIG. 10 shows the steps that are taken when executing a query. In step 1010, an initial query execution plan is generated by the coordinator. In step 1020, a top-down traversal of the query execution plan is performed and for each query operator, the following steps are performed. In step 1021, a signature is generated for the query operator. In step 1022, the cache storage area is searched using the signature of the query operator to find a corresponding cached table output. If a cached table output is found, the query operator and all of its children are replaced by a cached query operator indicating that the table output may be fetched from the cache storage area 1023. In step 1024, the sequence of steps starting from step 1021 is applied to the next query operator. If there is no more query operator to traverse in the query execution plan, the optimization of the query execution plan is completed. In step 1030, a bottom-up traversal of the query execution plan is performed, and the data table output of the query operator is generated by executing the query operator. In an embodiment, the execution of one or more query operators may be performed in parallel when it is possible.

In an environment with concurrent reads and writes to the database table, the coordinator may request a read lock on a data table before step 1020 of the method 1000 illustrated in FIG. 10. A table read lock prevents the data table to be modified concurrently during the generation of the query plan and until the execution of its parent query operators is completed. If a data table is modified during the generation of the query plan, it may impact the signature of a query operator or may cause inconsistency between the cached table output and the corresponding data table, which may lead to an incorrect data table output. A table read lock may be released once the data table is not used anymore. In an embodiment, the table read lock may be released after the execution of the query plan is completed or after all of the parent query operators of the data table are completed. A table read lock method and implementation is discussed later.

When the data table storage area is distributed across the computing nodes as explained in the method 800 of FIG. 8, the coordinator may request a read lock on a cached table output in step 1022 of the method 1000 when a cached table is found in the cache storage area. The read lock prevents the cached table output to be evicted or modified until the corresponding cached query operator is executed, and its table output is generated. If a cached table output is modified, this may lead to the generation of an incorrect or incomplete data table output. For example, due to the nature of a distributed shared nothing database architecture, a computing node may decide to evict a previously cached table output to make enough space for storing a new cached table output in its cache storage area after carrying out computation of another query operator. In that scenario and without a cache read lock, a cached table output found in step 1022 of the method 1000 may not exist anymore in step 1030 of the method 1000. A cache read lock may be released once the cached table output is not used anymore. In an embodiment, the cache read lock may be released after the execution of the query plan is completed or after all of the parent query operators of the data table are completed. A cache read lock method and implementation is discussed next.

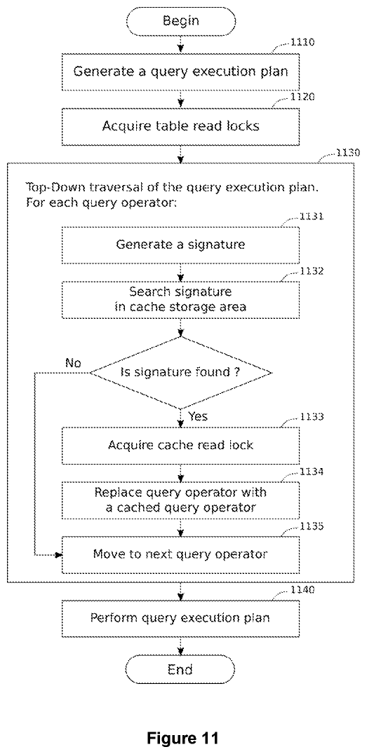

FIG. 11 is a flowchart showing a method 1100 that extends method 1000 with table and cache read locks. In step 1120, the coordinator acquires a read lock for every data table that may be referenced in the query execution plan. In step 1133, when a signature of a query operator is found in the cache storage area, the coordinator may request a read lock on the associated cached table output.

### Table Read Lock

Even with minimal read and write concurrent accesses, the use of table read locks may lead to lock contention issues and may cause a significant performance degradation. In an embodiment, a Multiversion Concurrency Control¹ method is implemented leveraging the log-structured storage system. ¹https://en.wikipedia.org/wiki/Multiversion_concurrency_control

In a log-structured storage system, an existing data table segment is never modified. An existing data table segment may only be deleted, or a new data table segment may be added. For example, a data table segment merge process may delete one or more segments and create a new segment.

A process may acquire a read lock on a data table segment by obtaining and storing a reference (for example, a reader) over the data table segment. This is equivalent to storing a snapshot of a data table segment at a time t. Until a data table segment is referenced by at least one process, the garbage collection will not reclaim it. Once a process releases its read lock, the reference of the data table segment is decremented. When the reference counter reaches 0, the garbage collection is executed, and the data table segment is deleted. The read lock prevents the data table segment to be deleted. It does not impact write performance as concurrent writes are performed in a new segment.

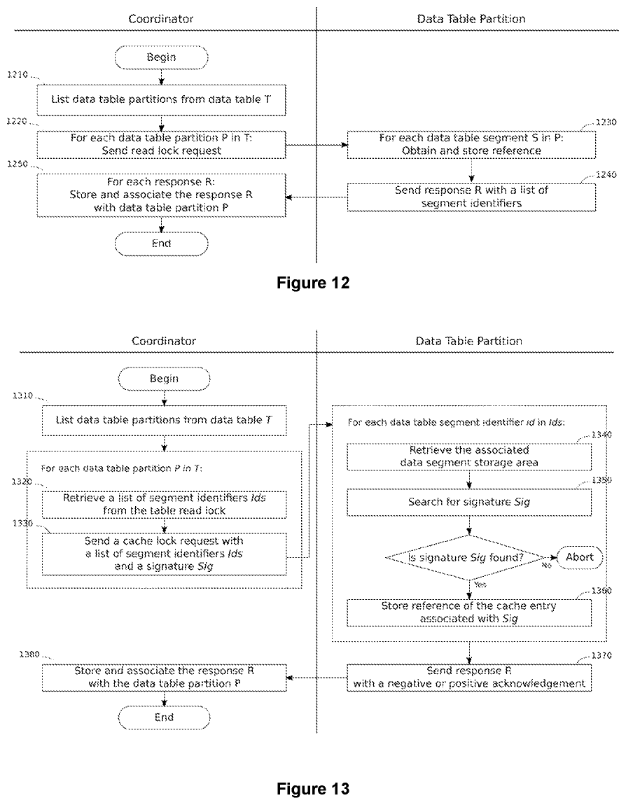

FIG. 12 is a flowchart showing a method 1200 of obtaining a table read lock in a distributed log-structured database, according to an embodiment of the present disclosure. In step 1210, the coordinator retrieves a list of data table partitions that are associated with a data table T. In step 1220, the coordinator sends a request to every data table partition P related to the data table T. In step 1230, each data table partition P in the data table T obtains and stores a reference at a time t for every data table segment S under its control. In step 1240, a data table partition sends a response back to the coordinator with a list of segment identifiers. In step 1250, the coordinator stores the response and associates it with its respective data table partition.

The identifier of a segment is used (1) when the coordinator sends a request to execute a scan query operator to every data table partition in order to access the snapshots of the corresponding data table segments; and (2) when the coordinator sends a request to release the read lock to every data table partition, in order to decrement the reference counter of the corresponding data table segments.

### Cache Read Lock

FIG. 13 is a flowchart showing a method 1300 of obtaining a cache read lock in a distributed log-structured database, according to an embodiment of the present disclosure. In step 1310, the coordinator retrieves a list of data table partitions that are associated with a data table T. In step 1320, the coordinator retrieves a list of segment identifiers from the table read lock of data table T. In step 1330, the coordinator sends a request to every data table partition P for searching a cached table output, based on a query operator signature Sig and a list of segment identifiers Ids that are obtained from a table read lock. In step 1340, each data table partition P accesses their data table partition storage area and retrieves the data segment storage areas based on the given list of segment identifiers Ids. In step 1350, the data table partition searches for the query operator signature Sig in the data segment storage areas. In step 1360, if the query operator signature Sig is found, the data table partition P stores a reference of the cached entry that is associated with the query operator signature Sig. In step 1370, a data table partition sends an acknowledgement response R back to the coordinator specifying that the cached table output was found or not. The acknowledgement is positive—if and only if—a query operator signature is found for every data segment. In step 1380, the coordinator stores the acknowledgement response R and associates it with the corresponding data table partition P. The coordinator may conclude that a cached table output exists for a given query operator signature and a given list of segment identifiers if and only if every data table partition is associated to a positive acknowledgement response.

In an embodiment, a process may store a reference over a cache entry alongside the reference of the data segment that is obtained during the table read lock. The reference over the cache entry may be automatically deleted once the table read lock is released.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

The present disclosure is not limited to the embodiment(s) described herein but can be amended or modified without departing from the scope of the present disclosure. Additionally, it will be appreciated that in embodiments of the present disclosure some of the above-described steps may be omitted and/or performed in an order that is other than that which is described.

Similarly the words comprises/comprising when used in the specification are used to specify the presence of stated features, integers, steps or components but do not preclude the presence or addition of one or more additional features, integers, steps, components or groups thereof.

1.-15. (canceled)

16. A method for accelerating the computation of a query execution plan involving semi-join query operators in a shared-nothing and log-structured database, the method comprising:
receiving a query;
generating a query execution plan, wherein the query execution plan comprises a plurality of query operators;
using the query operator to generate a signature;
executing a query operator to generate an output; and
using the signature to store the output of the query operator.

17. The method of claim 16, wherein executing the query operator to generate an output further comprises using the signature to retrieve a stored output of the query operator.

18. The method of claim 16, wherein generating the query execution plan further comprises rewriting a semi-join query operator to output record identifiers instead of the record itself.

19. The method of claim 16, wherein generating the query execution plan further comprises rewriting a semi-join query operator into a query operator that reuses stored output to generate its output.

20. The method of claim 16, wherein the output of the query operator is stored in a cache storage area.

21. The method of claim 20, further comprising dividing the cache storage area into one or more data table storage areas, data partition storage areas and data segment storage areas to preserve consistency of the record identifiers.

22. The method of claim 21, further comprising distributing the cache storage area across the data table partition storage areas.

23. The method of claim 21, wherein the data table storage areas are identified by a data table identifier, the data partition storage areas by a data table partition identifier and the data segment storage areas by a data table segment identifier, and the method further comprises deriving a global record identifier from the data table identifier, data table partition identifier and the data table segment identifier.

24. The method of claim 16, wherein using the query operator to generate the signature further comprises:
capturing the semantics of the query operator using its type, definition and lineage; and/or
capturing the semantics of a data table using its state.

25. The method of claim 24, wherein the state of the data table includes a set of records filtered by a plurality of filter operators.

26. The method of claim 16, wherein using the query operator to generate the signature further comprises:
generating a signature for a data table segment using a list of record identifiers;
generating a signature for a data table partition combining one or more signatures of data table segments; and
generating a signature for a data table combining one or more signatures of data table partitions.

27. The method of claim 16, wherein executing the query operator to generate the output further comprises:
acquiring a table read lock before generating the signatures of the query operators; and
acquiring a cache read lock when searching the signature in the cache storage area.

28. The method of claim 27, wherein the acquisition of the table read lock further comprises:
storing a reference of a data table segment at a time t; and
using a reference of a data table segment in the query plan execution.

29. The method of claim 27, wherein the acquisition of a cache read lock in a distributed shared-nothing and log-structured storage system further comprises:
storing a reference of a cache entry at a time t; and
using a reference of a cache entry in the query plan execution.

30. A non-transitory storage medium having stored therein computer-executable instructions which, when executed by one or more hardware processors, perform the following operations:
receive a query;
generate a query execution plan, wherein the query execution plan comprises a plurality of query operators;
use the query operator to generate a signature;
execute a query operator to generate an output; and
use the signature to store the output of the query operator.

31. A system, comprising:
one or more hardware processors; and
a non-transitory storage medium having stored therein computer-executable instructions which, when executed by the one or more hardware processors, perform the following operations:
receive a query;
generate a query execution plan, wherein the query execution plan comprises a plurality of query operators;
use the query operator to generate a signature;
execute a query operator to generate an output; and
use the signature to store the output of the query operator.
